(19) United States
(12) Patent Application Publication
(10) Pub. No.: US 2010/0320694 A1
(43) Pub. Date: Dec. 23, 2010

(54) APPARATUS, METHOD, AND SYSTEM FOR SEALING AN OBJECT OR A PLURALITY OF OBJECTS IN AN ASSEMBLY AND SEALING SAID ASSEMBLY AROUND AN APERTURE

(75) Inventor: GABRIEL P. GROMOTKA, PELLA, IA (US)

Correspondence Address: MCKEE, VOORHEES & SEASE, P.L.C., 801 GRAND AVENUE, SUITE 3200, DES MOINES, IA, 50309-2721, US

(73) Assignee: MUSCO CORPORATION, OSKALOOSA, IA (US)

(21) Appl. No.: 12/784,053

(22) Filed: May 20, 2010

Related U.S. Application Data
(60) Provisional application No. 61/218,302, filed on Jun. 18, 2009.

(51) Int. Cl. F16J 15/02; B29C 45/14; E04B 1/682

(52) U.S. Cl. 277/316; 425/500

(57) ABSTRACT

An apparatus, method, and system for sealing around an aperture in an enclosure; the aperture through which a plurality of wires, wire harness, or other objects, must pass. Injection of sealant into an assembly secured to the enclosure and about the wires, wire harness, or other objects ensures the components housed in the enclosure may be sealed against adverse effects while not limiting useful connection of the wires contained within the assembly to the enclosed components.

### CROSS-REFERENCE TO RELATED APPLICATIONS

This application claims priority under 35 U.S.C. §119 to provisional U.S. application Ser. No. 61/218,302, filed Jun. 18, 2009, hereby incorporated by reference in its entirety.

### BACKGROUND OF THE INVENTION

The present invention generally relates to sealing around an aperture in an enclosure through which wires, or other objects, pass such that components within the enclosure may be shielded against adverse effects.

It is well known that enclosures housing electrical components sensitive to environmental effects (e.g., sunlight, humidity) are generally sealed such that the components receive minimum exposure to said effects. One such method well known in the art is utilization of sealing ribs on the enclosure frame coupled with a complementary gasket (typically foamed in place) on one half of the enclosure frame such that when two halves of an enclosure are secured together (e.g., bolted, clamped), a seal is produced and the electrical components housed therein are protected from adverse environmental effects. However, as is also well known in the art, it is common for the components housed in an enclosure to be connected to one or more wires which must pass through an aperture in the enclosure and travel to some other location (e.g., another enclosure, another electrical component). Therefore, benefits gained from sealing the halves of the enclosure may be lost or compromised due to the aperture where the wires or other objects pass through the enclosure, unless there are means or methods for sealing the aperture itself.

FIG. 1A illustrates an example of half of a two-piece clamshell enclosure 100 which houses electrical components (indicated diagrammatically at reference no. 500) sensitive to environmental effects. Enclosure 100 includes a sealing rib 101 to aid in sealing; a gasket, generally complementary to sealing rib 101, is located on the other half of the clamshell (not illustrated). FIG. 1D gives a perspective view of the enclosure illustrated in FIG. 1A when the two-piece clamshell halves are assembled. As may be seen from FIG. 1A, each electrical component 500 may be connected to wires 400 which are guided by a wire retainer (an example of which is shown at reference no. 200) through an aperture 105 (see FIG. 1D) in enclosure 100; retainer 200 is secured at aperture 105 to enclosure 100 by bolts 201.

To address the insufficient sealing of enclosure 100, in the current state of the art a grommet (an example of which is shown at reference no. 300) is sometimes utilized such that a bare end 401 of each wire 400 is pulled through a hole 202 in retainer 200 (front and back views shown in isolation in FIG. 1B (i) and (ii)), through an aligned corresponding hole 302 in grommet 300 (shown in isolation in FIG. 1C), and into enclosure 100. Grommet 300 generally comprises a polymeric material (e.g., rubber, silicone) with holes 302 sized slightly smaller in diameter than that of wire 400 such that pulling of wire 400 through grommet 300 ensures a seal. As such, wire end 401 pulled into enclosure 100 is generally insulated but without a terminal, and thus, creates an insufficient means of connection to components 500. Once pulled through grommet 300 terminals (e.g., ring tongue, lugs)—shown diagrammatically on the right ends of wires 400—are attached manually (e.g., crimped, soldered) to end 401 of wire 400 in the enclosure, which is time-consuming and may be cost-prohibitive. Further, operator error is a concern; for example, terminals may be soldered to end 401 of wires 400 but if the heat from soldering is not regulated, components 500 may be damaged.

An alternative approach commonly used in the current state of the art to addressing the insufficient sealing at the aperture in an enclosure (e.g., such as enclosure 100 where wires 400 enter), as well as the insufficient connection between wire ends and components (see, e.g., reference nos. 401 and 500, respectively), is via use of a bisected apparatus (not shown) in which wires are laid and sealed. In this alternative approach, sealant is generally beaded across the wires laid in the apparatus, the halves of the apparatus are fastened, and the apparatus/wire assembly is generally fed through a retainer such as retainer 200 and through an aperture in the enclosure. While this alternative approach allows for the use of wires terminated on both ends, thus ensuring sufficient connection to components housed in the enclosure, there are drawbacks. For example, unless the apparatus completely covers the aperture in the enclosure, the enclosure is not properly sealed. Even if the apparatus completely covers the aperture in the enclosure the apparatus must be secured to the enclosure to ensure positioning, at which point the holes produced by securing the apparatus to the enclosure must be sealed. Further, beading of the sealant across the wires does not ensure uniform flow of sealant (e.g., sealant may leak out of the apparatus or air pockets may form from incomplete sealant flow). Thus, this alternative approach may also be cost-prohibitive, time-consuming, and subject to operator error.

### SUMMARY OF THE INVENTION

Methods of sealing a plurality of wires or other objects, including those that may be terminated on both ends, in an envisioned assembly that interfaces with an enclosure, are discussed. One typical application may be electrical enclosures housing environmentally sensitive components with wire connections that must pass through the enclosure. However, any sealed chamber with an aperture through which an object (or plurality of objects) must pass, particularly objects that may be economically or otherwise preferable to the application, including if said objects were enabled with terminals or other connections prior to sealing, would likewise benefit from aspects of the invention described herein.

It is therefore a principle object, feature, advantage, or aspect of the present invention to improve over and/or solve deficiencies in the state of the art.

Other objects, features, advantages, or aspects of the present invention may include an apparatus, method, or system for sealingly interfacing one or more wires or other objects through an aperture in and to the interior of an enclosure which:
a. can be efficiently and effectively used to interface one or more wires or other objects from outside to inside an enclosure, even if terminals or terminations on one or both ends of the wires or other objects, larger in outside diameter than the wires or other objects, are attached to one or both ends;
b. is very flexible in application, including:
   a. the same structure for any number of wires or other objects, if any, while still providing a seal at the aperture into the enclosure; and
   b. the same structure for setting lengths of each wire or other object either outside or inside the enclosure;
c. provides an integrated approach to sealing at the aperture to the enclosure, including providing a system and method that can address varying sealing and interfacing needs in an integrated manner;
d. can be used in a variety of applications;
e. can be used with a variable number of objects passing from outside the enclosure to the inside;
f. promotes accuracy, integrity, and uniformity of sealing from application to application; and
g. is quick, economical, and robust.

These and other objects, features, advantages, or aspects of the present invention will become more apparent with reference to the accompanying specification.

A method, apparatus, and system according to one aspect of the invention comprises a multiple-component assembly with a plurality of channels, receivers, or similar structures to align wiring (or other objects) of a desired length and also provide a flow path or paths for sealant or other injectable substance. Wires or other objects (one or more) are placed in one component of the assembly, the multiple components of the assembly are fastened, and the assembly itself is secured to an enclosure. In one aspect of the invention, when injected into the assembly, the flow of sealant or other injectable substance through channels or other pre-designed paths is such that the wires are sealed in place, the components of the assembly are sealed together, and the assembly itself is sealed to the enclosure, with improved uniformity over current art practices.

### BRIEF DESCRIPTION OF THE DRAWINGS

From time-to-time in this description reference will be taken to the drawings which are identified by Figure number and are summarized below.

FIG. 1A illustrates a plan view of one half of a clam-shell-type electrical enclosure interfaced with a wire retainer (shown in cross-section) via grommet according to one general method of the prior art.

FIG. 1B (i) and (ii) illustrate isolated, enlarged perspective front and back views, respectively, of the wire retainer in FIG. 1A.

FIG. 1C illustrates an isolated, enlarged perspective view of the grommet in FIG. 1A.

FIG. 1D is a perspective view of an assembled clam-shell type enclosure, showing an aperture through which wires or other objects pass from outside to inside the enclosure.

FIG. 2A is similar to FIG. 1A illustrating an electrical enclosure of the type of FIG. 1A but with a plurality of wires interfaced with the enclosure by an exemplary embodiment assembly (assembled and in cross-section) according to the present invention.

FIG. 2B illustrates a detailed enlarged, exploded perspective view of the multiple components of the assembly of FIG. 2A.

FIG. 2C illustrates a bottom view of the assembly of FIG. 2A when assembled and secured to an enclosure (not illustrated).

FIG. 2D illustrates a section view of the assembly illustrated in FIG. 2C taken along line 2D-2D of FIG. 2C.

FIG. 2E is an enlargement of the cross-section of the assembly from FIG. 2A, illustrating in more detail flow channels for sealant to and through various parts of the assembly, including diagrammatical use of arrows to illustrate such flow.

FIG. 3A (i) illustrates in perspective view the assembly of FIG. 2A, when assembled and operatively mounted in an aperture of an enclosure. FIG. 3A (ii) diagrammatically illustrates the flow of sealant, when injected through the assembly, according to one exemplary embodiment.

FIG. 3B (i) is the same as FIG. 3A (i), but FIG. 3B (ii) diagrammatically illustrates the flow of sealant through the assembly, when assembled, according to an alternate exemplary embodiment.

FIG. 4 illustrates in enlarged perspective view one possible design of an accessory component to partially plug mold cavities in the assembly illustrated in FIGS. 2A-2E, 3A, and 3B.

### DETAILED DESCRIPTION OF EXEMPLARY EMBODIMENTS

To further understanding of the present invention, specific exemplary embodiments according to the present invention will be described in detail. Aspects according to the present invention envision methods of producing a seal around an aperture in an enclosure through which a plurality of wires or other objects must pass. The resulting system is such that ease of installation and sealant flow uniformity is improved over current state of the art practices, as well as reduction of cost, time-consumption, and operator error. It is of note, however, that the exemplary embodiments described herein are by way of example and not by way of limitation.

Frequent mention will be made in this description to the drawings. Reference numbers will be used to indicate certain parts in the drawings. The same reference numbers will be used to indicate the same or similar parts throughout the drawings (for example, 100 to denote an enclosure).

As has been stated, aspects of the invention described herein envision methods of injecting sealant into channels in an envisioned assembly such that wires or other objects laid in the channels may be sealed in place, the components of the assembly may be sealed together, and the apparatus itself may be sealed to an enclosure. There are a variety of methods available for injecting sealant or other injectable material into an assembly or onto a surface. For example, a chamber may be attached to a nozzle such that, when the chamber is compressed by hand, sealant or other injectable material is injected from the chamber through the nozzle; this method is well known in the field of art crafting (e.g., white glue). Alternatively, a similar chamber with attached nozzle may be compressed mechanically to inject sealant; this method is well known in the field of seam repair (e.g., caulking). The exemplary embodiments described herein utilize the latter method of injecting sealant; however, any method of injecting sealant or injectable substance into an assembly may be utilized without departing from aspects of the invention. It is also of note that the exemplary embodiments described herein utilize commercially available self-curing liquid sealant (i.e., sealant that does not require application of heat, pressure, etc.); however, any sealant or injectable substance or material which may be injected into an assembly, and cure by some means such that an effective seal as may be needed or defined by a particular application exists, may be utilized without departing from aspects of the invention.

### A. Exemplary Method and Apparatus Embodiment 1

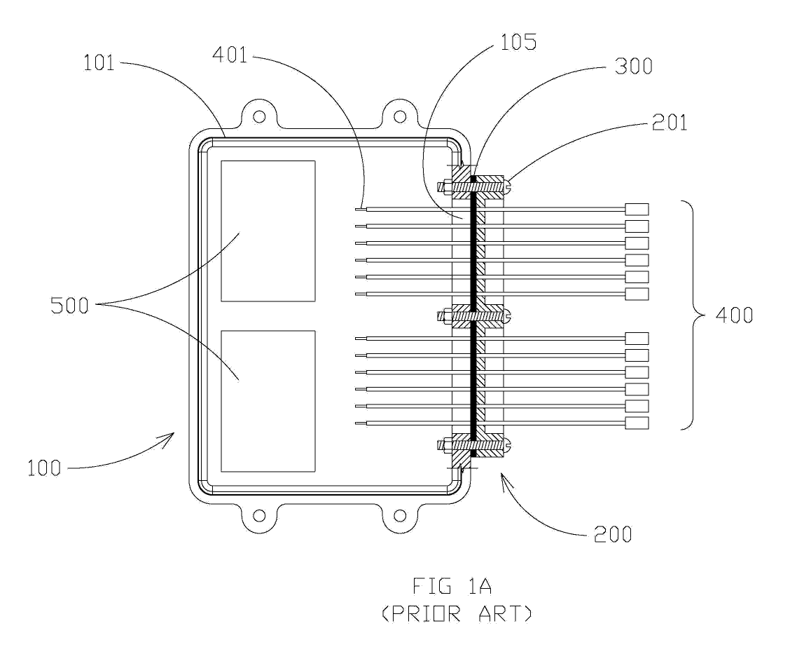

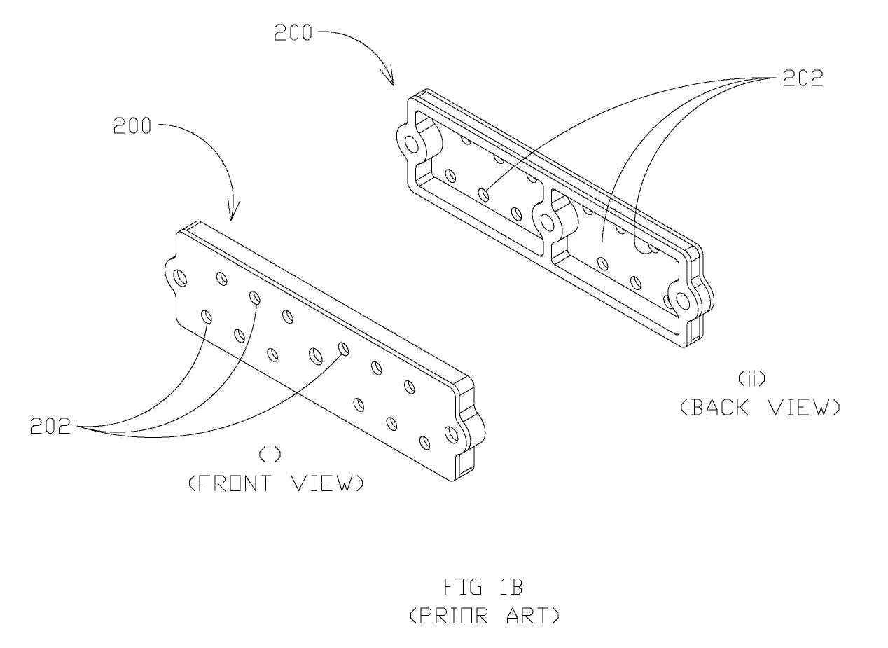

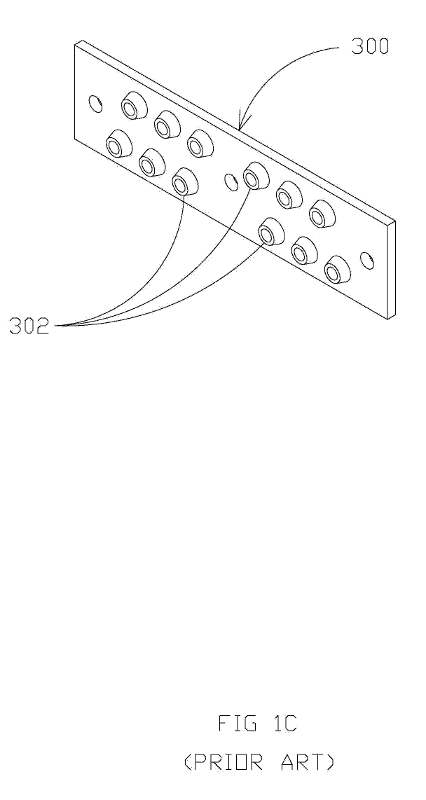

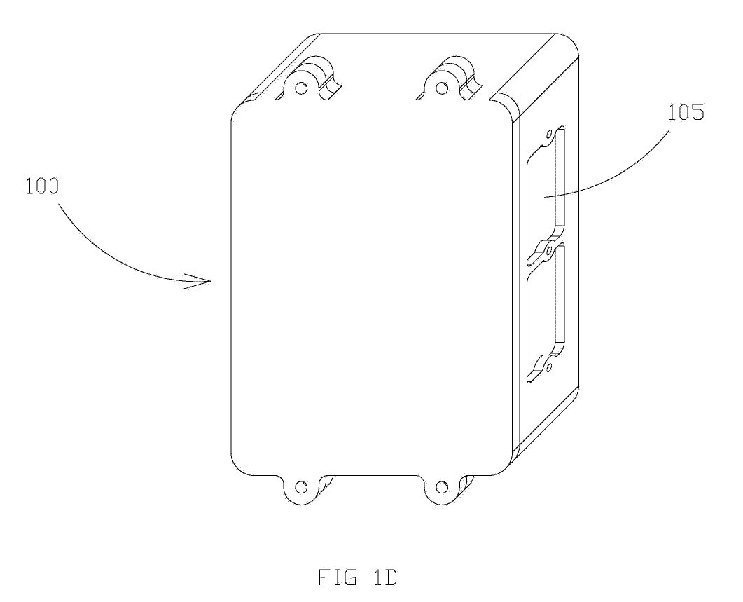

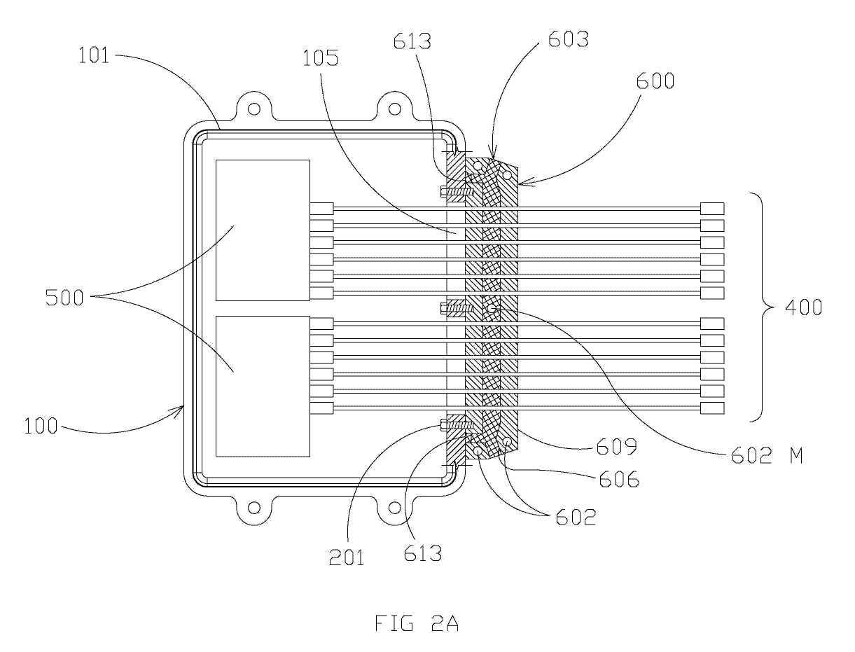

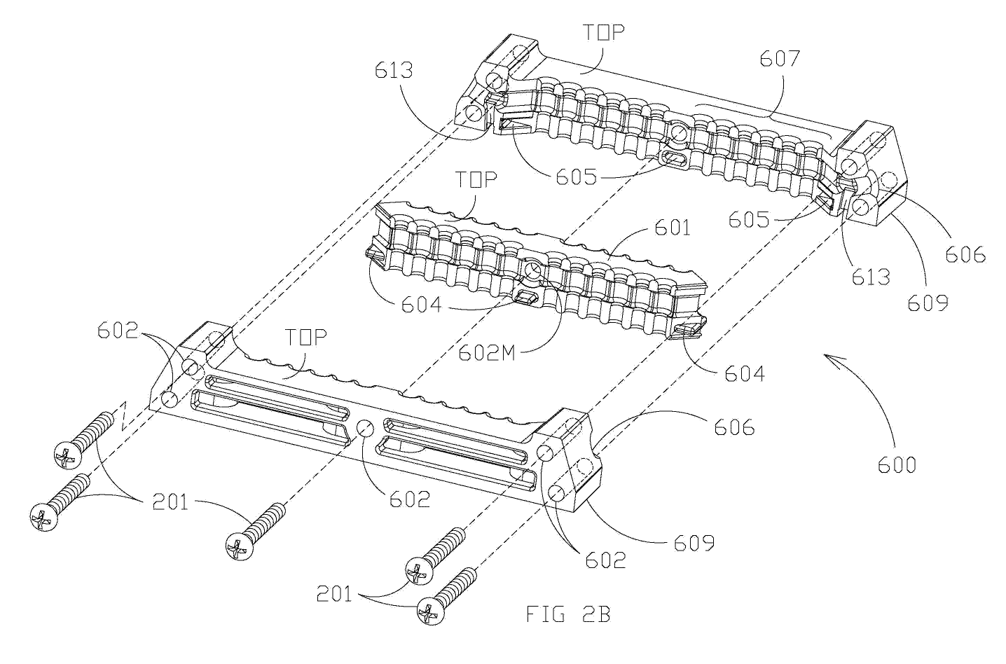

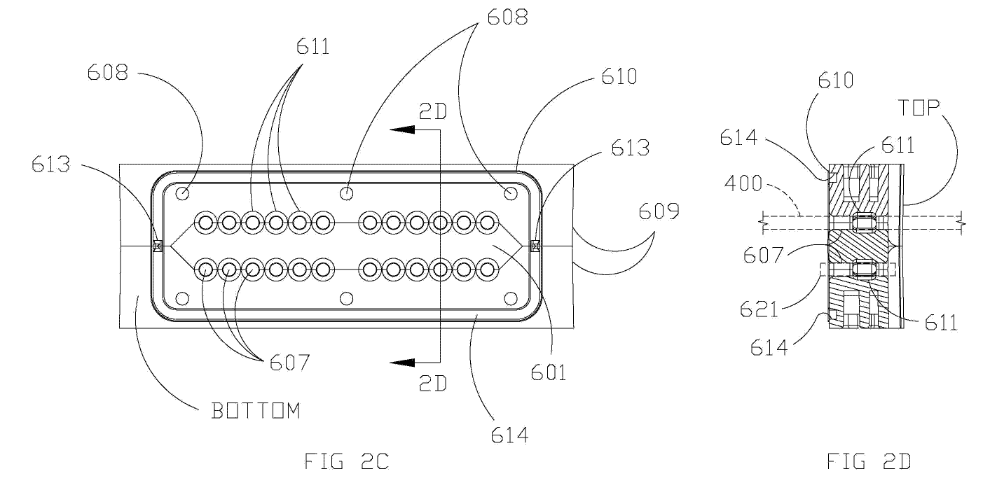

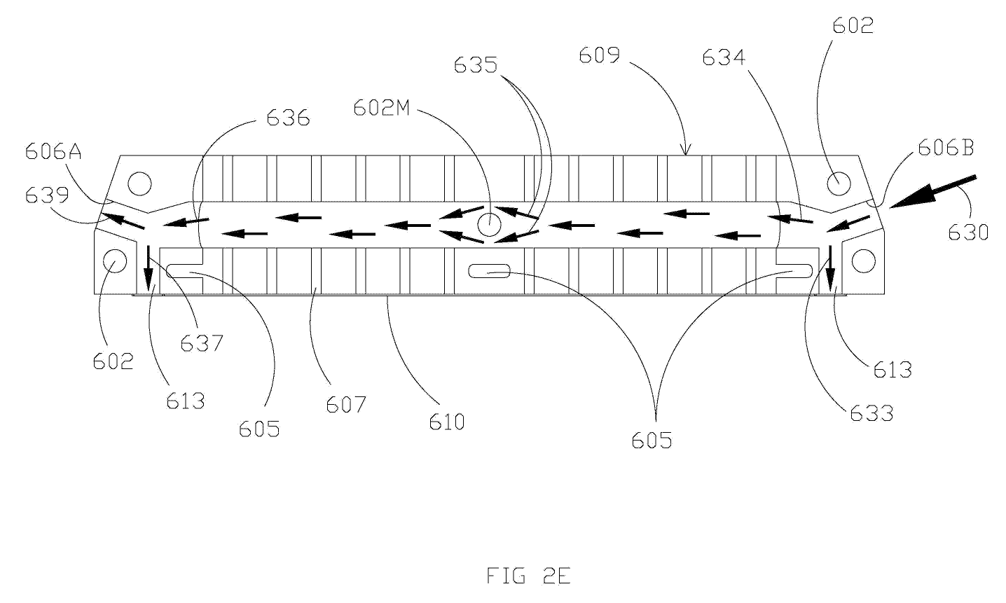

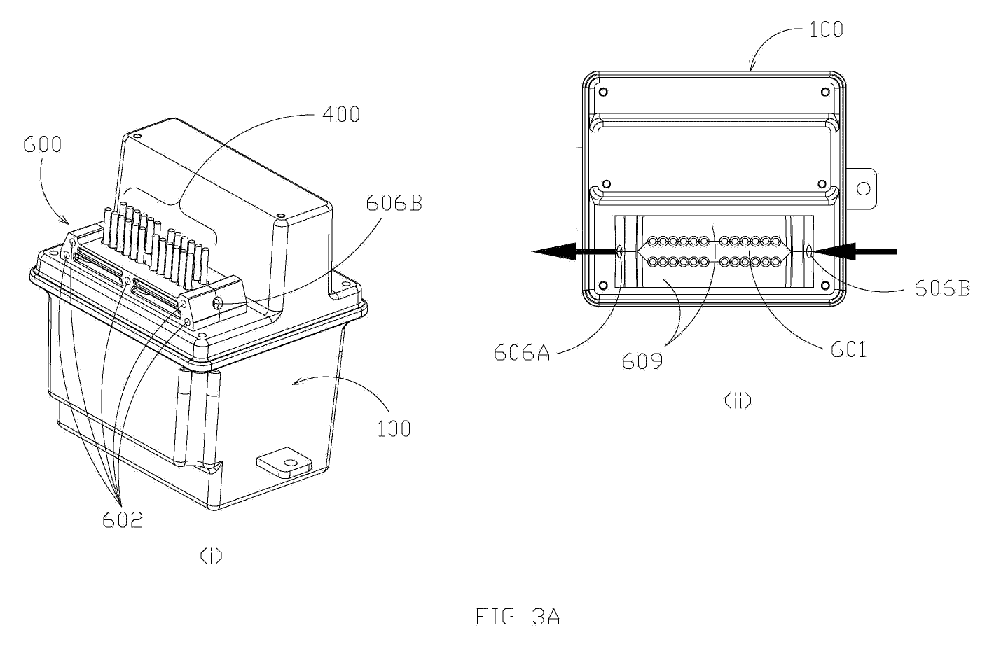

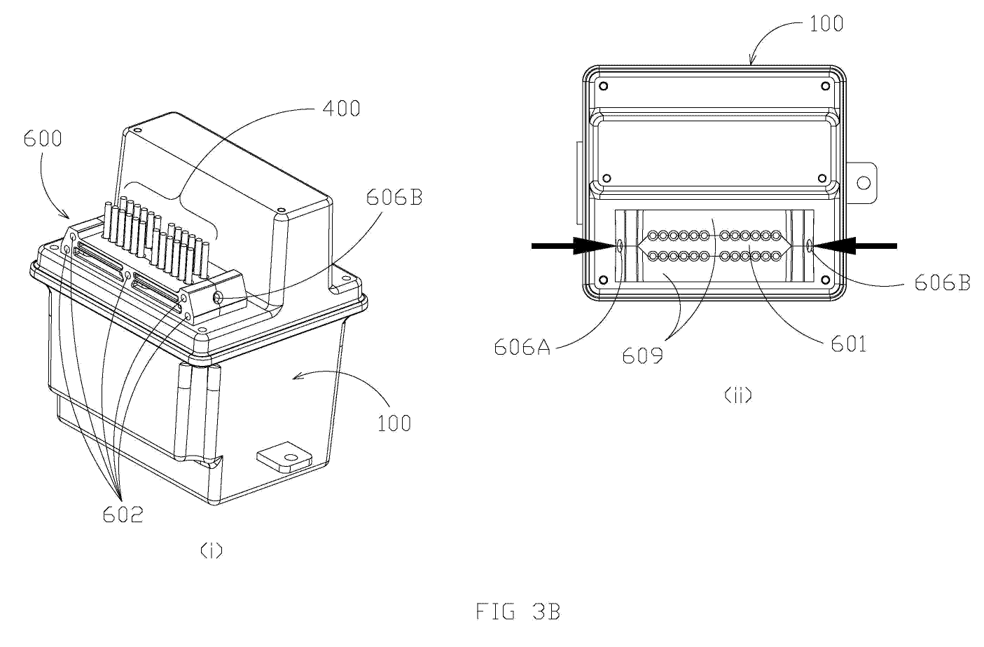

As is illustrated in FIGS. 2A and 3A, an electrical enclosure 100 houses components 500 (e.g., electrical or electronic devices) which are connected to wires 400 which are, in turn, fed out an aperture 105 in the side of enclosure 100 (for reference, FIG. 1D illustrates in isolation an enclosure 100 with its aperture 105). A three-part assembly 600 (see also FIGS. 2A-2E) aligns wires 400 and, when secured to the enclosure 100 via bolts 201 and injected with sealant 603, seals wires 400 within assembly 600, seals the components of assembly 600 together, and seals assembly 600 to enclosure 100. One of the benefits of the design of assembly 600 is such that wires 400 (or other objects) may be laid and sealed with a desired length in enclosure 100 and a desired length outside enclosure 100. For example, assume three wires are to be placed in assembly 600 and connected to components 500 within enclosure 100; in this example, the first wire is 6″ long, the second wire is 12″ long, and the third wire is 18″ long. A user may lay each wire in their respective positions within assembly 600 such that when sealed, exactly 3″ of each wire extends outwardly from enclosure 100 (leaving 3″, 9″, and 15″, respectively, extending through assembly 600 into aperture 105). Alternatively, exactly 3″ of each wire could extend into enclosure 100 via aperture 105. This is useful because, for example, often there is limited room in an enclosure for wiring, wiring lengths must be equal to maintain a balanced load, or wiring length must be exact to determine electrical losses.

FIG. 2B illustrates an exploded perspective top view of assembly 600 in which two outer molds 609, when brought together, enclose or clamp an inner mold 601 and are secured by bolt(s) 201 (or other fastener or fastening method) at connection points 602; keys 604 on both sides of inner mold 601 mate with key holes, slots, or receivers 605 on the two outer molds 609 to ensure alignment of the three components (609, 601, 609). When fully assembled, a plurality of wires 400 may be secured in mold cavities 607 (here two rows of twelve wire-holding cavities 607 per row) of assembly 600; as illustrated in FIG. 2B, twenty-four mold cavities 607 are produced when assembly 600 is fully assembled, though this is by way of example and not by way of limitation. When pieces 609, 601, and 609 are assembled, mold cavities 607 form an increase in diameter at the center of the longitudinal axis of the cavity (reference no. 611) to provide a series of channels through which sealant 603 may flow from one sprue 606 to another while concurrently sealing wires 400 in place. Further, the flow of sealant 603 through assembly 600 concurrently fills a series of channels surrounding each connection point 602 such that the components (609, 601, 609) of assembly 600 are connected and sealed together.

FIG. 2C illustrates a bottom view of assembly 600 when assembled and secured to the enclosure (not illustrated) at connection points 608 with bolts 201 (see FIGS. 2A and 2B). As may be seen from FIGS. 2C-2D, injection of sealant 603 through the sprue (see reference no. 606) and down channel 613 creates a seal at and extending from an exposed rectangular bottom channel 614 that surrounds connection points 608 (i.e., forms a rectangular perimeter around all six connection points 608), thus ensuring a more complete seal against enclosure 100 than in current art practices. Current art grommet design 300 (FIGS. 1A-1C) typically limits the number and positioning of apertures through which bolts or other hardware may be used to secure grommet 300 to enclosure 100 which limits the flexibility of the sealing method. Further, if bolts or other hardware used to secure grommet 300 to enclosure 100 are not sized compliantly with the apertures in the grommet 300 the enclosure 100 may be insufficiently sealed. In the present exemplary embodiment sealant 603 bonds to the adjacent exterior surface of enclosure 100 around aperture 105 and creates a perimeter seal around connection points 608, thus allowing any number of connection points 608 and size of bolt (or other hardware) to be utilized, provided connection points 608 are positioned within the perimeter of sealant 603.

FIG. 2E, in combination with the FIGS. 2A-D, is intended to further illustrate how one injection of sealant into sprue 606 may not only move sealant to and around each wire 400 at each enlarged portion 611 of each side-by-side cavity 607 (each portion 611 is in fluid communication and allows flow of sealant between opposite sprues 606A and 606B even with wires in cavities 607), but in this embodiment, through other channels to connection points or bores 602 and to bottom exposed rectangular channel 614. This flow of sealant through different paths will be described with reference to the diagrammatic arrows 630-639 in FIG. 2E, which are intended to depict the flow of sealant 603 in the embodiment where sealant 603 is injected into one sprue 606.

Sealant enters sprue 606B on one side of assembly 600 (arrow 630). Sealant advances towards the path through the side-by-side cavities 607 (arrow 634). This would both seal and help connect together (when the sealant cures) the two pieces 609 of assembly 600. Also, some sealant would flow through into bottom rectangular channel 614 by the path shown in FIG. 2E by arrow 633 and side channel 613 (see also FIGS. 2B and 2C). When the bottom side of assembly 600 is fastened against the exterior of enclosure 100 at and around aperture 105, the configuration of bottom channel 614 is designed to be outside aperture 105 and be exposed to solid surface of enclosure 100 surrounding aperture 105. When sealant fills bottom channel 614, it would also move out against the adjacent surface of housing 100. When cured, it thus forms a rectangular seal around aperture 105 and around the six bolts fastening assembly 600 to housing 100 at mounting threaded blind bores 608 in the bottom of assembly 600. This is similar to a gasket between assembly 600 and enclosure 100, but also the sealant may assist in connection of assembly 600 to enclosure 100 by any adherent or adhesive characteristics.

As further shown in FIG. 2E, sealant would flow in the direction of arrow 634 and fill all spaces not occupied by wires 400 in cavities 607. Note that some sealant (arrow 635) may flow into connection point 602M, which is at or near the middle of cavities 607, and may assist in sealing around any fastener extending through all aligned bores 602 from side to side of assembly 600, as well as help connect pieces 609, 601, and 609 of assembly 600.

Sealant would continue in the direction of the arrows across cavities 607 towards the other side of assembly 600. At arrow 636, sealant may split off into side channel 613 to fill bottom channel 614 (arrow 637) to further help produce the bottom seal between assembly 600 and enclosure 100. Sealant would also move to fill opposite sprue 606A (arrow 639), to complete the sealant injection through assembly 600 and seal the connection between pieces 609, 601, and 609 of assembly 600, respectively.

As may be appreciated, other flow channels may be pre-designed into assembly 600. Furthermore, alternative embodiments may just design a flow path through cavities 607 to seal wires 400 and not have flow paths into connection points 602 or not have a bottom channel 614. But in the first exemplary embodiment all of these flow paths and features are combined. This allows an integrated system for sealing wires, but also for sealing and helping to connect pieces of assembly 600, as well as sealing and helping to connect assembly 600 relative to enclosure 100.

FIG. 3A (i) and (ii) illustrate the assembly from FIGS. 2B-2D assembled, securing a plurality of wires 400, and secured to an enclosure 100. Sealant is then injected into assembly 600, the flow of which may generally be characterized by the following.
Sealant is injected into sprue 606B as indicated diagrammatically by the arrow entering assembly 600 in FIG. 3A (ii).
Sealant flows around each wire 400 via channels in mold cavities 607 (see also examples in FIGS. 2C-2E), thus sealing each wire in assembly 600 and sealing the components (609, 601, 609) at connection points 602M.
   Concurrently, bottom channel 614 fills with sealant, thus sealing assembly 600 to enclosure 100.
   Concurrently, side channels 613 fill with sealant, thus sealing the components (609, 601, 609) of assembly 600 together at connection points 602 (see also examples in FIG. 2B).
      It is of note that bolts or other hardware used to secure the components (609, 601, 609) of assembly 600 together at connection points 602 are not illustrated in FIG. 3A (see FIGS. 2A-2E for possible examples).
When sealant has filled all channels and cavities, excess sealant flows out sprue 606A as indicated by the arrow exiting assembly 600 in FIG. 3A (ii), thus giving a clear indication that the injection process is complete.

### B. Exemplary Method and Apparatus Embodiment 2

An alternative exemplary embodiment of the invention envisions an electrical enclosure 100 housing components 500 which are connected to wires 400 which are, in turn, fed out an aperture in the enclosure 100 as in FIGS. 2A and 3B. As in Exemplary Method and Apparatus Embodiment 1, a three-part assembly 600 (see also FIGS. 2A-2E) aligns wires 400—each wire 400 may be selectively placed in assembly 600 such that a desired length will extend into enclosure 100 and a desired length will extend outwardly from enclosure 100—and, when secured to enclosure 100 via bolts 201 and injected with sealant 603, seals wires 400 within assembly 600, seals the components (609, 601, 609) of assembly 600 together, and seals assembly 600 to enclosure 100. In this alternative exemplary embodiment, the device injecting sealant 603 into assembly 600 is enabled with means of measuring resistance to injection (e.g., internal pressure).

FIG. 3B illustrates assembly 600 from FIGS. 2A-2E assembled, securing a plurality of wires 400, and secured to an enclosure 100. Sealant is then injected into assembly 600, the flow of which may generally be characterized by the following.
Sealant is injected into both sprues 606A and 606B as indicated diagrammatically by the arrows entering the assembly 600 in FIG. 3B (ii).
Sealant flows around each wire 400 via channels in mold cavities 607, thus sealing each wire in assembly 600 and sealing the components (609, 601, 609) at connection points 602M.
   Concurrently, the bottom channel fills with sealant, thus sealing assembly 600 to the enclosure 100.
   Concurrently, the side channels fill with sealant, thus sealing the components (609, 601, 609) of assembly 600 together at connection points 602.
      It is of note that bolts or other hardware used to secure the components (609, 601, 609) of assembly 600 together at connection points 602 are not illustrated in FIG. 3B.
When sealant has filled all channels and cavities, the device injecting the sealant will register a significant increase in resistance to injection (e.g., internal pressure of assembly 600 will increase), thus giving a clear indication that the injection process is complete. Further, excess sealant may flow out of the top of mold cavities 607 where wire 400 exits assembly 600, thus giving a clear indication that the injection process is complete.

### C. Options and Alternatives

The invention may take many forms and embodiments. The foregoing examples are but a few of those. To give some sense of some options and alternatives, a few examples are given below.

As described in Exemplary Method and Apparatus Embodiments 1 and 2 the components (609, 601, 609) of assembly 600 are secured together by bolt(s) 201; assembly 600 is secured to enclosure 100 by bolt(s) 201 as well. It is of note that any method of securing the components (609, 601, 609) of assembly 600 together, as well as securing assembly 600 to an enclosure 100, may be utilized and not depart from aspects of the invention described herein. Further, assembly 600 or enclosure 100 could have guide pins, positioning tabs, or analogous structural features to help position and center assembly 600 relative to enclosure 100 about aperture 105.

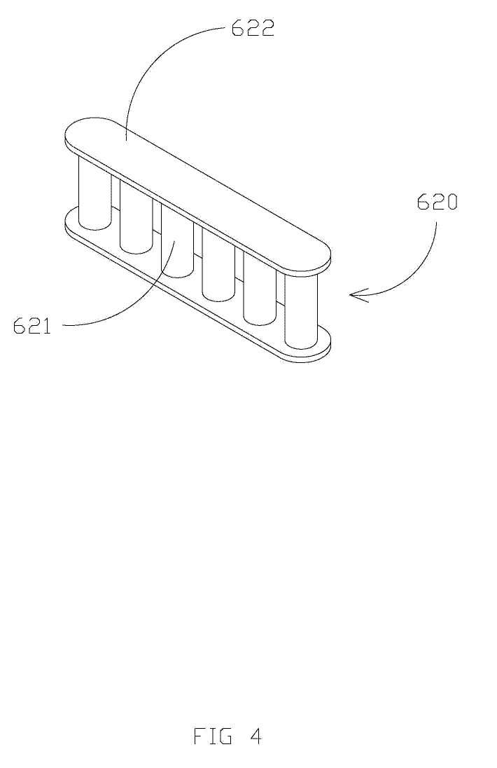

As described in Exemplary Method and Apparatus Embodiments 1 and 2 assembly 600 houses twenty-four mold cavities 607 in which wires 400 may be secured. It is of note that assembly 600 may house any number of mold cavities 607, may secure any length of wire 400 with any desired amount of that length on either side of assembly 600, and may secure objects other than wires, and not depart from aspects of the invention described herein. Further, a plurality of mold cavities 607 may secure wires 400 or other objects while another plurality of mold cavities 607 may be plugged or otherwise partially obstructed, and not depart from aspects of the invention described herein. For example, if assembly 600 illustrated in FIG. 3A secured eighteen wires 400 (instead of the twenty-four illustrated) the six empty mold cavities may be plugged by a simple component 620, such as that illustrated in FIG. 4, so as not to impede the flow of sealant 603 but also to prevent sealant from leaking out of unused mold cavities. Elongated members 621 of component 620 would generally fit in cavities 607. Upper and lower webbing 622 may sit flush on the top and bottom faces, respectively, of assembly 600 (see FIG. 2B for orientation reference); webbing 622 may aid a user in handling component 620 as elongated members 621 may be very small. Component 620 may be made of rubber, plastic, or other material that may be formed to assume a generally complementary shape to the space to be filled up, but does not completely fill the space as sealant may then flow around and past and finalize a seal. Component 620 may be easily inserted into position and may be used in whole or broken or separated into a lesser number of members 621, if needed. The design of component 620 may vary as is needed for the application so long as flow of sealant 603 is not impeded.

As described in Exemplary Method and Apparatus Embodiments 1 and 2 assembly 600 comprises two outer molds 609 and one inner mold 601 such that two rows of mold cavities 607 exist when the components (609, 601, 609) are assembled. It is of note that a plurality of combinations of outer molds 609 and inner molds 601 may be utilized for a particular application and not depart from aspects of the invention described herein. For example, if it is desirable for assembly 600 to secure a single row of mold cavities 607, then only outer molds 609 may be used. As a further example, if it is preferable for assembly 600 to secure three rows of mold cavities 607, then two outer molds 609 may be used in conjunction with two inner molds 601.

As described in Exemplary Method and Apparatus Embodiments 1 and 2, when assembly 600 is fully assembled, secured to enclosure 100, and injected with sealant, a seal is formed against the outer surface of enclosure 100 about aperture 105 via bottom channel 614. Though not required, it may be desirable to include features which help to dam sealant in channel 614 and prevent undesirable spread of sealant on the surface of enclosure 100 or into aperture 105. One way this can be achieved is via crush ribs 610 on both sides of bottom channel 614 (see FIGS. 2C-E); as is well known in the art, crush ribs are very small (e.g., on the order of a millimeter or less in height and thickness) deformable extensions of material which crush down when two parts are brought together (e.g., for purposes of sealing between parts or allowing for an interference fit). Alternatively, an o-ring or other analogous device could be placed on both sides of channel 614 such that, when assembly 600 is affixed to enclosure 100, the o-ring or analogous device would be compressed between assembly 600 and enclosure 100, thus helping to prevent the undesired spread of sealant beyond bottom channel 614.

As described in Exemplary Method and Apparatus Embodiments 1 and 2, sealant 603 is injected into assembly 600 by a device comprising a chamber containing sealant 603 that is compressed mechanically and a nozzle to apply sealant 603. It is of note that the device as described utilizes a nozzle shaped to match the sprue (606A, 606B), however, any nozzle shape that may be fitted to the sprue (606A, 606B) may be utilized and not depart from aspects of the invention described herein. Alternatively, the sprue (606A, 606B) shape may be altered to match a particular nozzle type if it may be beneficial to the application. Other methods to inject sealant or the like may be used.

As described in Exemplary Method and Apparatus Embodiment 2 the device which injects sealant into assembly 600 is enabled with means of measuring resistance to injection. It is of note that there are several methods by which resistance to injection may be measured, and such methods may be enabled for assembly 600 as well as the device injecting sealant. For example, internal pressure of the chamber holding the sealant or internal pressure of assembly 600 may be measured (e.g., via pressure sensor or strain gage applied to said chamber or assembly 600) in a variety of locations (e.g., on the external body of assembly 600 or on the internal body of assembly 600 through a bored hole). As an alternative to measuring pressure, e.g., a sensor placed on assembly 600 may monitor air flow out of the mold cavities while wires are secured in place. In such alternative method, injection of the sealant may be complete when there is no longer a significant air flow out of assembly 600 as determined by measurement or calculation. Any means of measuring resistance to injecting sealant into a mold (including a user feeling a notable resistance to compression of the plunger or analogous part of the injection device) may be utilized and not depart from aspects of the invention described herein.

What is claimed is:

1. A method of sealing one or more wires or other objects, each wire or other object having a length and opposite ends, at an aperture in an enclosure comprising:
a. positioning each wire or other object in channels in one piece of a multiple-piece apparatus;
b. clamping the diameter or thickness of an intermediate section of each wire or other object between the one piece and another piece of the apparatus such that the opposite ends of the wire or other object are on opposite sides of the two pieces and available for connection to another component or to a terminal or termination;
c. installing the apparatus at the aperture of the enclosure such that one side of the two pieces abuts the enclosure, one end of the wire or other object extends into the enclosure, and the opposite end of the wire or other object extends out from the opposite side of the two pieces and away from the enclosure; and
d. injecting sealant into the apparatus such that:
a. each wire or other object is sealed in its clamped position in the apparatus; and
b. the apparatus is sealed against the enclosure at and around the aperture.

2. The method of claim 1 wherein attached to at least one end of the one or more wires or other objects is a terminal, termination, or connector that is larger than the diameter or thickness of the wire or other object.

3. The method of claim 1 wherein the sealant is flowable in a first state and cures to an adhering and resilient but non-flowable state.

4. The method of claim 3 wherein the sealant is injected into the apparatus at multiple locations in the apparatus.

5. A method of installing one or more wires or other objects from outside to inside an enclosure box through an aperture in the enclosure box comprising:
a. clamping or positioning a portion of each wire or other object between two pieces such that opposite ends of the wire or other object are on opposite sides of the two pieces and available for connection to another component or to a terminal or termination;
b. installing the pieces at the aperture of the enclosure box;
c. channeling a sealant around each wire or other object so that a seal may be made between the outside and inside of the enclosure box at the aperture and at each wire or other object;
d. channeling the sealant around a portion of the pieces adjacent to the aperture of the enclosure box to seal the pieces at the aperture of the enclosure box;
e. channeling the sealant between the pieces to seal and connect the pieces;
f. so that a sealed interface is created between the pieces and the enclosure box, between the wires or other objects and the pieces, and between the pieces.

6. The method of claim 5 wherein the number of wires or other objects is variable.

7. The method of claim 6 wherein the variability comprises providing a plurality of receivers for a given number of wires or other objects and selecting from one to the given number for clamping between the pieces each in a receiver.

8. The method of claim 7 further comprising a plug for each receiver not used for a wire or other object.

9. The method of claim 5 further comprising attaching a terminal or termination to at least one end of a said wire or other object prior to clamping between the two pieces.

10. An apparatus for interfacing one or more wires or other objects between the outside and inside of an enclosure box through an aperture in the enclosure box comprising:
a. first and second pieces each having complimentary portions forming a plurality of cavities through the pieces when assembled, the cavities adapted to receive a portion of a wire or other object so that opposite ends of each wire or other object are free and exposed on opposite sides of the pieces;
b. the cavities being pre-formed to have portions in fluid communication with adjacent cavities when the pieces are assembled;
c. a pre-formed channel of larger perimeter dimensions than the aperture of the enclosure box and in fluid communication with at least a cavity;
d. a pre-formed channel between the pieces in fluid communication with at least one cavity;
e. a sprue in fluid communication with at least one cavity;
f. so that sealant may be introduced into the sprue and flow through all cavities, the pre-formed channel of larger perimeter dimensions than the aperture, and the other channels to seal the wires or other objects in the pieces, seal the pieces to the enclosure box when mounted at the aperture, and seal the pieces to each other.

11. The apparatus of claim 10 further comprising a second sprue such that sealant may be introduced into both sprues and flow through all cavities until a desired resistance to sealant introduction is reached.

12. The apparatus of claim 10 further comprising a termination or terminal operatively connected to at least one end of a said wire or other object prior to placement in a receiver.

13. The apparatus of claim 10 wherein the wires or other objects are adapted for operative connection inside the enclosure box to one or more electrical or electronic components.

14. The apparatus of claim 10 further comprising a first formation of crush ribs of larger perimeter dimensions than the aperture but of smaller perimeter dimensions than the pre-formed channel of larger perimeter dimensions than the aperture and a second formation of crush ribs of larger perimeter dimensions than the pre-formed channel of larger perimeter dimensions than the aperture.

15. The apparatus of claim 10 further comprising one or more pieces having structure to nest between the first and second pieces, and including complementary portions that create cavities with the first and second pieces similar to described in claim 10.

16. A method of sealing plural wires which pass from outside to inside an enclosure box through an aperture in the enclosure box comprising:
a. laying or positioning the wires across a first member;
b. assembling a second member to the first member across opposite sides of the wires laying or positioned in the first member;
c. attaching the assembled first and second members to the enclosure box at the aperture;
d. directing a flowable substance through the assembled first and second members to:
a. seal the wires in the assembled first and second members;
b. seal the assembled first and second members;
c. seal the assembled first and second members to the enclosure box.

17. The method of claim 16 wherein the wires comprise first and second subsets of wires, the first subset of wires positioned between the first member and a third member adapted to be assembled between the first and second members, the second subset of wires positioned between the second member and the third member, thereafter assembling the first, second, and third members and mounting the assembled first, second, and third members to the enclosure box, thereafter directing a flowable substance through the assembled first, second, and third members to:
a. seal the wires in the assembled first, second, and third members;
b. seal the assembled first, second, and third members;
c. seal the assembled first, second, and third members to the enclosure box.
